(19) United States
(12) Patent Application Publication
(10) Pub. No.: US 2014/0108363 A1
(43) Pub. Date: Apr. 17, 2014

(54) Encoding/Decoding Processing Method, Encoder/Decoder and Terminal

(71) Applicant: Huawei Device Co., Ltd., Shenzhen (CN)

(72) Inventor: Yun Guo, Beijing (CN)

(73) Assignee: Huawei Device Co., Ltd., Shenzhen (CN)

(21) Appl. No.: 14/140,359

(22) Filed: Dec. 24, 2013

Related U.S. Application Data
(63) Continuation of application No. PCT/CN2011/083049, filed on Nov. 28, 2011.

(51) Int. Cl. G06F 17/30

(52) U.S. Cl. CPC G06F 17/30371
USPC 707/693

(57) ABSTRACT

Embodiments of the present invention provide an encoding/decoding processing method, an encoder/decoder, and a terminal. The method includes determining whether a field in a file is a locally recognizable field. If the field is not a locally recognizable field, the method includes acquiring a field display identifier of the field, where the field display identifier is a content identifier of the field displayed by an application to a user, and decoding the field according to the field display identifier. According to the technical solutions in the embodiments of the present invention, it can be ensured that data is not lost in a process of exchanging a VCard file, thereby improving efficiency of exchanging the VCard file.

This application is a continuation of International Application No. PCT/CN2011/083049, filed on Nov. 28, 2011, which is hereby incorporated by reference in its entirety.

### TECHNICAL FIELD

Embodiments of the present invention relate to the field of electronic technologies, and in particular, to an encoding/decoding processing method, an encoder/decoder and a terminal.

### BACKGROUND

With popularization of devices embedded in a terminal and boom of the Internet technologies, the requirement of exchanging address book content is increasingly common. An electronic business card (VCard) is an electronic form of a personal business card that includes the address book content, and is used to meet the requirement of exchanging business cards between different electronic devices. The VCard specification provides definitions and specifications for exchanging business cards between different electronic devices, and the VCard specification can ensure consistency between data before the exchange of a business card and data after the exchange of the business card.

In the prior art, the process of exchanging a VCard file is divided into two processes: encoding and decoding. On an encoder side, an encoder encodes address book entries in an address book application into a VCard file according to field content, and for a field undefined in the VCard specification, may add the field into an “X-” field to fulfill the purpose of extending a customized field. On a decoder side, after receiving the VCard file, a decoder parses the VCard file into corresponding address book entries according to the VCard specification, and provides the entries for a personal information management (PIM) application to use. In addition, in the existing VCard exchanging process, due to incompatibility between the encoder and the decoder, the decoder side recognizes each field first before performing the decoding. For an unrecognizable field, because the decoder does not know how the field is defined, the decoder cannot provide field information for the PIM application after the decoding. As a result, the PIM application cannot display the field correctly. Therefore, the decoder side generally discards the unrecognizable field before the decoding.

In conclusion, in the existing process of exchanging a VCard file, the decoder side processes the unrecognizable field in a discarding manner, which leads to data loss in the process of exchanging the VCard file.

### SUMMARY OF THE INVENTION

Embodiments of the present invention provide an encoding/decoding processing method, an encoder/decoder, and a terminal to overcome a defect, where the defect is as follows: in an existing process of exchanging a VCard file, a decoder side processes an unrecognizable field in a discarding manner, which leads to data loss in the process of exchanging the VCard file.

An embodiment of the present invention provides an encoding processing method. The method includes acquiring a field display identifier corresponding to a field, where the field display identifier is a content identifier of the field displayed by an application to a user. The method further includes encoding the field display identifier as a part of the field, so that when a decoder that decodes the field does not recognize the field, the decoder acquires the field display identifier corresponding to the field and decodes the field according to the field display identifier.

An embodiment of the present invention provides a decoding processing method. The method includes determining whether a field in a file is a locally recognizable field. If the field is not a locally recognizable field, the method includes acquiring a field display identifier of the field, where the field display identifier is a content identifier of the field displayed by an application to a user. The method also includes decoding the field according to the field display identifier.

An embodiment of the present invention provides an encoder. The encoder includes an acquiring module and an encoding module. The acquiring module is configured to acquire a field and a field display identifier corresponding to the field. The encoding module is configured to encode the field display identifier acquired by the acquiring module as a part of the field, so that when a decoder that decodes the field does not recognize the field, the decoder acquires the field display identifier corresponding to the field and decodes the field according to the field display identifier.

An embodiment of the present invention provides a decoder. The decoder includes a determining module, an acquiring module, and a decoding module. The determining module is configured to determine whether a field in a file is a locally recognizable field. The acquiring module is configured to acquire a field display identifier of the field if a determining result of the determining module is that the field is not a locally recognizable field. The field display identifier is a content identifier of the field displayed by an application to a user. The decoding module is configured to decode the field according to the field display identifier acquired by the acquiring module.

An embodiment of the present invention further provides a terminal, where the foregoing encoder and/or the foregoing decoder is arranged in the terminal.

According to the encoding/decoding processing method, the encoder/decoder, and the terminal in the embodiments of the present invention, by adopting the foregoing technical solutions, a decoder side is capable of acquiring a field display identifier of a locally unrecognizable field so as to recognize the locally unrecognizable field, thereby ensuring that the locally unrecognizable field is not discarded in the process of decoding performed by the decoder. According to the technical solutions in the embodiments of the present invention, the locally unrecognizable field can be recognized, and a data loss problem caused by incompatibility between a decoder and an encoder in the prior art can be overcome. According to the technical solutions in the embodiments of the present invention, it can be ensured that data is not lost in a process of exchanging a VCard file, thereby improving efficiency of exchanging the VCard file.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other embodiments from these accompanying drawings without creative efforts.

FIG. 1 is a flowchart of an encoding processing method according to an embodiment of the present invention;

FIG. 2 is a flowchart of a decoding processing method according to an embodiment of the present invention;

FIG. 3 is a flowchart of a decoding processing method according to another embodiment of the present invention;

FIG. 4 is a schematic structural diagram of an encoder according to an embodiment of the present invention;

FIG. 5 is a schematic structural diagram of a decoder according to an embodiment of the present invention; and

FIG. 6 is a schematic structural diagram of a decoder according to another embodiment of the present invention.

### DETAILED DESCRIPTION OF ILLUSTRATIVE EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

FIG. 1 is a flowchart of an encoding processing method according to an embodiment of the present invention. An entity for performing the encoding processing method in this embodiment is an encoder. As shown in FIG. 1, the encoding processing method in this embodiment may specifically include the following steps.

100. The encoder acquires a field display identifier corresponding to a field.

The field display identifier in this embodiment is a content identifier of the field displayed by an application to a user. Because the field display identifier is already stored in a terminal, the field display identifier can be acquired from a storage location of the field display identifier in the encoding process, for example, the field display identifier corresponding to the field may be acquired from a related database table.

101. The encoder encodes the field display identifier as a part of the field, so that when a decoder that decodes the field does not recognize the field, the decoder acquires the field display identifier corresponding to the field and decodes the field according to the field display identifier.

That is, compared with the prior art, a file on which the encoding processing in steps 100 and 101 is performed carries the field display identifier additionally. If the decoder cannot recognize the field when the encoded file is sent to the decoder side, the field can be recognized according to the field display identifier and decoding can be implemented on the field, thereby overcoming a defect of data loss that occurs when the decoder directly discards a locally unrecognizable field in the prior art.

Optionally, the file in this embodiment may be a VCard file or a file of another similar format that is obtained through encoding performed by another encoder. In this case, in step 101, the encoder encodes the field display identifier as a part of the field to obtain an encoded field. Specifically, the encoder may encode the field display identifier as a part of the field according to the VCard specification to obtain the encoded field.

According to the encoding processing method in this embodiment, the encoder is capable of encoding the field display identifier as a part of the field, thereby ensuring that when the decoder that decodes the field does not recognize the field, the decoder is capable of acquiring the field display identifier and decoding the field according to the field display identifier. According to the technical solution in this embodiment of the present invention, it can be ensured that the decoder recognizes a locally unrecognizable field, and a data loss problem caused by incompatibility between a decoder and an encoder in the prior art can be overcome. According to the technical solution in this embodiment of the present invention, it can be ensured that data is not lost in a process of exchanging a file, thereby improving efficiency of exchanging the file.

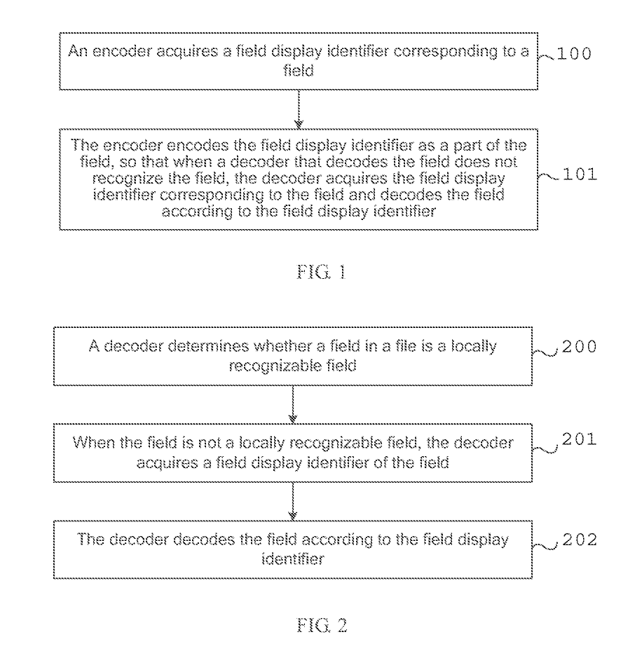

FIG. 2 is a flowchart of a decoding processing method according to an embodiment of the present invention. An entity for performing the decoding processing method in this embodiment is a decoder. As shown in FIG. 2, the decoding processing method in this embodiment may specifically include the following steps.

200. The decoder determines whether a field in a file is a locally recognizable field.

Optionally, the field in this embodiment includes at least a field name and a field value, where the field value refers to specific field content information to be transmitted. For example, the field name of a received field is a TEL field, and the field value is information content “137****4567” to be transmitted. Optionally, the file in this embodiment may be a VCard file.

201. When the field is not a locally recognizable field, the decoder acquires a field display identifier of the field.

The field display identifier in this embodiment is a content identifier of the field displayed by an application to a user. For example, if the TEL field cannot be recognized, the field display identifier of the TEL field may be acquired first, where an example of the display identifier of the TEL field is “telephone number.” In this way, it is evident that the content of the TEL field, which is finally displayed by the application to the user, is a telephone number.

202. The decoder decodes the field according to the field display identifier.

In this embodiment, the received field that is locally recognizable can be decoded by the decoder directly. For details, reference may be made to the prior art, and no repeated description is given here.

In the decoding processing method in this embodiment, whether a field in a received file is a locally recognizable field is determined. If the field is not a locally recognizable field, a field display identifier of the field is acquired, and a decoder decodes the field according to the field display identifier. According to the technical solution in this embodiment, a locally unrecognizable field can be recognized, and a data loss problem caused by incompatibility between a decoder and an encoder in the prior art can be overcome. According to the technical solution in this embodiment, it can be ensured that data is not lost in a process of exchanging a file, thereby improving efficiency of exchanging a VCard file.

In the prior art, incompatibility occurs between a device on an encoder side and a device on a decoder side. For example, the encoder side is capable of recognizing a field in a VCard file but the decoder side cannot recognize it. In this case, the decoder side generally discards the field before decoding. In the technical solution of the foregoing embodiment, however, the decoder may first acquire the field display identifier of the unrecognizable field, and then the decoder may fill a data structure of corresponding address book data with the field display identifier in the decoding process according to corresponding specifications of the file, thereby completing decoding of the field. Further, optionally, the address book data decoded by the decoder may carry the field display identifier, and the application may acquire the decoded address book data that carries the field display identifier and display it to the user. As regards how the decoder performs the decoding, reference may be made to the VCard specification in the prior art, and no repeated description is given here.

Optionally, based on the technical solution of the foregoing embodiment, after step 201 and before step 202, or after step 202, the method may further include: (1) acquiring a field name of the field from the field; and (2) storing the field name of the field and the field display identifier into a local information base according to a mapping relationship.

The received field in this embodiment carries the field name. The field name may be directly acquired from the field, and then the field name and the field display identifier are stored into a local information base according to a mapping relationship. In this way, when the field is received again, the field display identifier corresponding to the field can be obtained from the local information base, so that the decoder performs decoding according to the VCard specification. Optionally, the local information base in this embodiment may be newly created or existent in an existing system on the decoder side.

Optionally, on the basis of the technical solution of the foregoing embodiment, determining whether the received field is a locally recognizable field in step 201 specifically includes determining whether the field name of the field is stored in the local information base. If the field name of the field is stored in the local information base, it further includes determining that the field is a locally recognizable field, or if the field name of the field is not stored in the local information base, it further includes determining that the field is not a locally recognizable field. The local information base pre-stores field names of all locally recognizable fields and corresponding field display identifiers.

Optionally, based on the technical solution of the foregoing embodiment, before step 200, the method may further include: (1) collecting the field names of all locally recognizable fields and corresponding field display identifiers; and (2) storing the collected field names of all the fields and the corresponding field display identifiers into the local information base.

Optionally, on the basis of the technical solution of the foregoing embodiment, when the received field can further carry the field display identifier, if the field further carries the field display identifier and the field is not a locally recognizable field in step 201, acquiring the field display identifier of the field may specifically include acquiring the field display identifier from the field when the field is not a locally recognizable field.

In this case, because the field carries the field display identifier, it may be required that the field display identifier of the field be carried in the field on the encoder side. Specifically, the field display identifier of the field may be defined before the encoding is performed on the encoder side.

Optionally, the received field may also carry no field display identifier. In this case, when the field is not a locally recognizable field in step 201, acquiring a field display identifier of the field may specifically include: (1) when the field is not a locally recognizable field, sending an input prompt to a display device so that the user configures the field display identifier for the field, where the input prompt carries the field name and the field value of the field; and (2) receiving the field display identifier input by the user through a man-machine interface module.

When the field received by a field recognition processing apparatus on the decoder side is not a locally recognizable field, an input prompt may be sent to the display device first, where the input prompt carries the field name and the field value of the field. In this way, when seeing the input prompt on the display device, the user may learn that the field is a locally unrecognizable field. The user may determine what the field is according to the field name and the field value, and further, the corresponding field display identifier configured by the user for the field may be input through the man-machine interface module. The field display identifier may be a content identifier of the field that is expected by the user to display locally.

Optionally, based on the technical solution of the foregoing embodiment, that “the decoder decodes the field according to the field display identifier” in step 202 may specifically include the following steps: (1) acquiring a field value of the field; and (2) storing the field display identifier and the field value.

In the prior art, for a locally recognizable field, after a field value is acquired through decoding on the decoder side, the field value of the field needs to be stored so that the field value of the field can be displayed later. For example, in the prior art, the field value of the field may be stored in a database or a table entry used for storing the field value acquired through decoding, or the corresponding field name of the field may further be stored in the database or table entry. According to the technical solution of the embodiment of the present invention, at the time of decoding, the field value of the field may be acquired from the field in the file first, and then the field display identifier of the field and the corresponding field value are stored together. For example, they may be stored in the database or table entry used for storing the field value acquired through decoding in the prior art, so that the field is displayed subsequently according to the field display identifier and the field value. For example, for a locally unrecognizable field x-mail, if the acquired field display identifier of the field is “email” and the field value is aaa@tom.com, the decoder needs to store the field display identifier “email” and the field value aaa@tom.com into the database or table entry used for storing the field value acquired through decoding, so that the field is displayed subsequently according to the field display identifier and the field value.

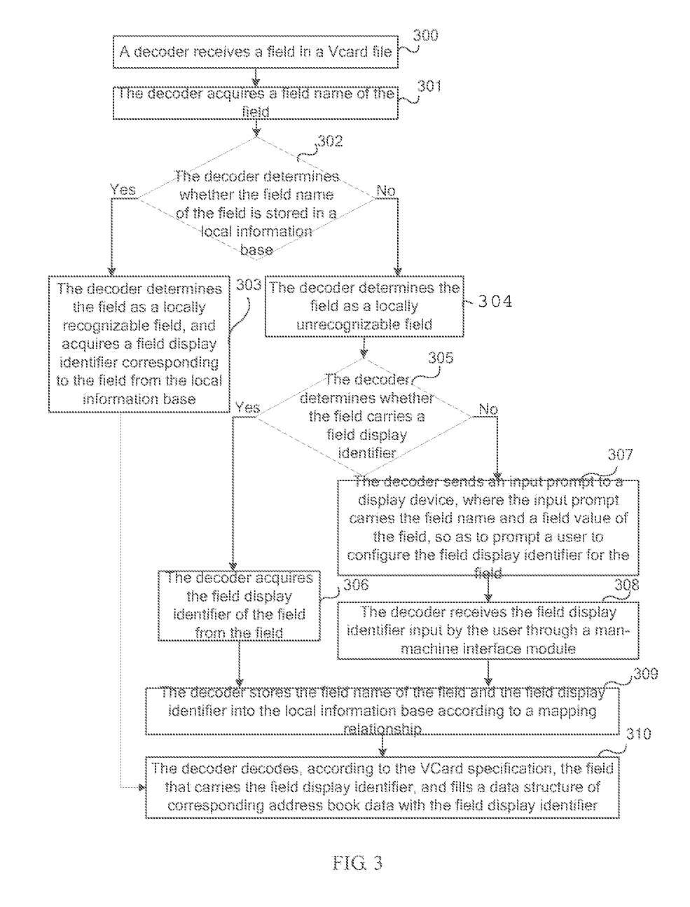

FIG. 3 is a flowchart of a decoding processing method according to another embodiment of the present invention. As shown in FIG. 3, on the basis of the embodiment shown in FIG. 2, taking a VCard file as an example, the following describes the technical solution of the present invention in further detail, and the decoding processing method in this embodiment of the present invention may specifically include the following steps.

300. A decoder receives a field in a Vcard file, and proceeds to step 301.

301. The decoder acquires a field name of the field, and proceeds to step 302.

302. The decoder determines whether the field name of the field is stored in a local information base. If the field name of the field is stored, the decoder proceeds to step 303. If the field name of the field is not stored, the decoder proceeds to step 304.

303. The decoder determines the field as a locally recognizable field, and acquires the field display identifier corresponding to the field from the local information base, and then proceeds to step 310.

304. The decoder determines the field as a locally unrecognizable field, and then proceeds to step 305.

305. The decoder determines whether the field carries a field display identifier. If the field carries the field display identifier, the decoder proceeds to step 306. If the field carries no field display identifier, the decoder proceeds to step 307.

306. The decoder acquires the field display identifier of the field from the field, and then proceeds to step 309.

307. The decoder sends an input prompt to a display device, where the input prompt carries the field name and the field value of the field, so as to prompt a user to configure the field display identifier for the field. The decoder then proceeds to step 308.

308. The decoder receives the field display identifier input by the user through a man-machine interface module, and then proceeds to step 309.

309. The decoder stores the field name of the field and the field display identifier into the local information base according to a mapping relationship, and then proceeds to step 310.

310. The decoder decodes, according to the VCard specification, the field that carries the field display identifier, and fills a data structure of corresponding address book data with the field display identifier.

The manner of decoding the field by the decoder corresponds to the manner of encoding on the encoder side. For example, when performing decoding, the decoder may acquire the field value of the field from the field, and then store the field display identifier and the corresponding field value.

Subsequently, further, the application on the decoder side may acquire the decoded address book data from the decoder, where the address book data carries the field display identifier and the field value. The application may display the field to the user according to the field display identifier and the field value. Because the address book data carries the field display identifier, the application may determine, according to the field display identifier, how to display the field, thereby correctly displaying the field.

The field recognition processing method in this embodiment is capable of recognizing the locally unrecognizable field by using the foregoing technical solution, thereby overcoming a data loss problem caused by incompatibility between a decoder and an encoder in the prior art. According to the technical solution in this embodiment, it can be ensured that data is not lost in a process of exchanging a VCard file, thereby improving efficiency of exchanging the VCard file.

A person of ordinary skill in the art should understand that all or part of the steps of the methods in the embodiments may be implemented by a program instructing relevant hardware. The program may be stored in a computer readable storage medium. When the program runs, the steps of the methods in the embodiments are performed. The storage medium may be any medium capable of storing program codes, such as a ROM, a RAM, a magnetic disk, an optical disk, or the like.

FIG. 4 is a schematic structural diagram of an encoder according to an embodiment of the present invention. As shown in FIG. 4, the encoder in this embodiment includes an acquiring module 10 and an encoding module 11.

The acquiring module 10 is configured to acquire a field and a field display identifier corresponding to the field, where the field display identifier is a content identifier of the field displayed by an application to a user. The encoding module 11 is connected to the acquiring module 10, and the encoding module 11 is configured to encode the field display identifier acquired by the acquiring module 10 as a part of the field, so that when a decoder that decodes the field does not recognize the field, the decoder acquires the field display identifier corresponding to the field and decodes the field according to the field display identifier.

The encoder in this embodiment uses the foregoing technical modules to implement the encoding processing based on the same implementation mechanism as the foregoing related method embodiment. For details, reference may be made to the description in the foregoing related method embodiment, and no repeated description is given here.

According to the encoder in this embodiment, the encoder is capable of encoding a field display identifier as a part of a field by using the foregoing technical modules, so that when a decoder that decodes the field does not recognize the field, the decoder acquires the field display identifier and decodes the field according to the field display identifier. According to the technical solution in this embodiment of the present invention, it can be ensured that the decoder recognizes a locally unrecognizable field, and a data loss problem caused by incompatibility between a decoder and an encoder in the prior art can be overcome. According to the technical solution in this embodiment of the present invention, it can be ensured that data is not lost in a process of exchanging a file, thereby improving efficiency of exchanging the file.

FIG. 5 is a schematic structural diagram of a decoder according to an embodiment of the present invention. As shown in FIG. 5, the decoder in this embodiment may specifically include a determining module 20, an acquiring module 21, and a decoding module 22.

The determining module 20 is configured to determine whether a field in a file is a locally recognizable field. The acquiring module 21 is connected to the determining module 20, and the acquiring module 21 is configured to acquire a field display identifier of the field if a determining result of the determining module 20 is that the field is not a locally recognizable field. The field display identifier is a content identifier of the field displayed by an application to a user. The decoding module 22 is connected to the acquiring module 21, and the decoding module 22 is configured to decode the field according to the field display identifier acquired by the acquiring module 21.

The decoder in this embodiment uses the foregoing modules to implement the decoding processing based on the same implementation mechanism as the foregoing related method embodiment. For details, reference may be made to the description in the foregoing related method embodiment, and no repeated description is given here.

By using the foregoing modules, the decoder in this embodiment is capable of determining whether a field in a received file is a locally recognizable field. If the field is not a locally recognizable field, the decoder acquires a field display identifier of the field and decodes the field according to the field display identifier. According to the technical solution in this embodiment, a locally unrecognizable field can be recognized, and a data loss problem caused by incompatibility between a decoder and an encoder in the prior art can be overcome. According to the technical solution in this embodiment, it can be ensured that data is not lost in a process of exchanging a file, thereby improving efficiency of exchanging a VCard file.

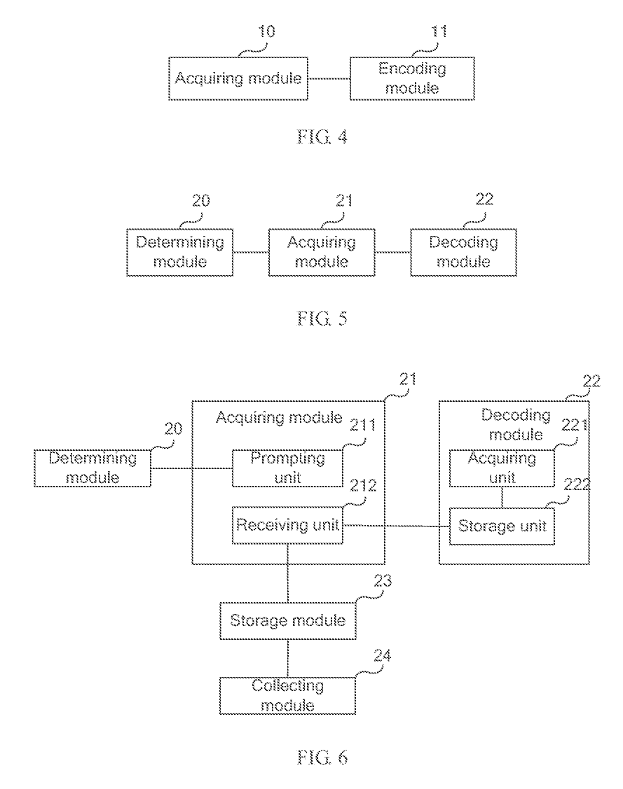

FIG. 6 is a schematic structural diagram of a decoder according to another embodiment of the present invention. As shown in FIG. 6, on the basis of the embodiment shown in FIG. 5, the decoder in this embodiment may further include a storage module 23. The acquiring module 21 is further configured to acquire a field name of the field from the received field. The storage module 23 is connected to the acquiring module 21, and the storage module 23 is configured to store the field name and the field display identifier that are acquired by the acquiring module 21 into a local information base according to a mapping relationship.

Optionally, in the field recognition processing apparatus in this embodiment, the determining module 20 is specifically configured to determine whether the field name of the field is stored in the local information base. If the field name of the field is stored in the local information base, the determining module 20 determines that the field is a locally recognizable field. If the field name of the field is not stored in the local information base, the determining module 20 determines that the field is not a locally recognizable field. The local information base pre-stores field names of all locally recognizable fields and corresponding field display identifiers.

Optionally, the field recognition processing apparatus in this embodiment further includes a collecting module 24. Specifically, the collecting module 24 is configured to collect the field names of all locally recognizable fields and the corresponding field display identifiers. The storage module 23 is further connected to the collecting module 24, and the storage module 23 is further configured to store the field names of all fields and the corresponding field display identifiers that are collected by the collecting module 24 into the local information base.

Optionally, in the field recognition processing apparatus in this embodiment, the acquiring module 21 is specifically configured to acquire the field display identifier from the field when the field is not a locally recognizable field.

Optionally, as shown in FIG. 6, in the field recognition processing apparatus in this embodiment, the acquiring module 21 may further include a prompting unit 211 and a receiving unit 212. The prompting unit 211 is configured to send an input prompt to a display device so that a user configures the field display identifier for the field, where the input prompt carries the field name and a field value of the field. The receiving unit 212 is configured to receive the field display identifier input by the user through a man-machine interface module. In this case, the corresponding storage module 23 may be connected to the acquiring module 21 and the receiving unit 212 (as shown in FIG. 6), and the storage module 23 is configured to store the field name of the field acquired by the acquiring module 21 and the field display identifier received by the receiving unit 212 into the local information base according to a mapping relationship, where the field name and the field display identifier serve as information about the locally recognizable field. In this case, correspondingly, the decoding module 22 is connected to the receiving unit 212, and the decoding module 22 is configured to decode the field according to the field display identifier received by the receiving unit 212.

Optionally, in the field recognition processing apparatus in this embodiment, the decoding module 22 includes an acquiring unit 221 and a storage unit 222. The acquiring unit 221 is configured to acquire the field value of the field. The storage unit 222 is connected to the acquiring module 21 and the acquiring unit 221, and the storage unit 222 is configured to store the field display identifier acquired by the acquiring module 21 and the field value acquired by the acquiring unit 221.

Further, when the acquiring module 21 is specifically implemented by the prompting unit 211 and the receiving unit 212, as shown in FIG. 6, the storage unit 222 may be connected to the receiving unit 212 and the acquiring unit 221, and the storage unit 222 is configured to store the field display identifier received by the receiving unit 212 and the field value acquired by the acquiring unit 221.

In the decoder in the embodiment shown in FIG. 6, the technical solutions in the embodiments of the present invention are described by assuming that multiple optional technical solutions coexist. In practical application, the multiple optional technical solutions may exist separately or be combined in any way to form the embodiment of the present invention, the details of which are not given here.

The decoder in this embodiment uses the foregoing modules to implement the decoding processing based on the same implementation mechanism as the foregoing related method embodiment. For details, reference may be made to the foregoing related method embodiment, and no repeated description is given here.

By using the foregoing modules, the decoder in this embodiment is capable of recognizing a field that cannot be locally recognized by the decoder, thereby overcoming a data loss problem caused by incompatibility between a decoder and an encoder in the prior art. According to the technical solution in this embodiment, it can be ensured that data is not lost in a process of exchanging a VCard file, thereby improving efficiency of exchanging the VCard file.

An embodiment of the present invention may further provide a terminal, where the terminal includes the encoder shown in FIG. 4 and/or the decoder shown in FIG. 5 or FIG. 6. For details, reference may be made to the description in the foregoing related embodiment, and no repeated description is given here.

By using the foregoing encoder and/or decoder, the terminal provided in this embodiment is capable of recognizing a field that cannot be locally recognized by the decoder, thereby overcoming a data loss problem caused by incompatibility between a decoder and an encoder in the prior art. According to the technical solution in this embodiment, it can be ensured that data is not lost in a process of exchanging a VCard file, thereby improving efficiency of exchanging the VCard file.

The foregoing described apparatus embodiment is merely exemplary. The units described as separate parts may or may not be physically separate, and parts displayed as units may or may not be physical units, may be located in one position, or may be distributed on at least two network units. A part or all of the modules may be selected according to actual needs to achieve the objectives of the solutions of the embodiments. A person of ordinary skill in the art may understand and implement the embodiments without creative efforts.

Finally, it should be noted that the foregoing embodiments are merely intended for describing the technical solutions of the present invention, rather than limiting the present invention. Although the present invention is described in detail with reference to the foregoing embodiments, a person of ordinary skill in the art should understand that he may still make modifications to the technical solutions described in the foregoing embodiments, or make equivalent replacements to some technical features thereof, without departing from the spirit and scope of the technical solutions of the embodiments of the present invention.

What is claimed is:

1. An encoding processing method, the method comprising:
acquiring a field display identifier corresponding to a field, wherein the field display identifier comprises a content identifier of the field displayed by an application to a user;
encoding the field display identifier as a part of the field; and
sending the field with the field display identifier in a file to a decoder, so that when the decoder that decodes the field does not recognize the field, the decoder acquires the field display identifier and decodes the field according to the field display identifier.

2. A decoding processing method, the method comprising:
receiving a file from an encoder, wherein the file comprises a field display identifier corresponding to a field, wherein the field display identifier is encoded as a part of the field;
determining whether the field in the file is a locally recognizable field;
if the field is determined not to be a locally recognizable field, acquiring the field display identifier, wherein the field display identifier comprises a content identifier of the field displayed by an application to a user; and
decoding the field according to the field display identifier.

3. The method according to claim 2, wherein the field is determined not to be a locally recognizable field.

4. The method according to claim 2, further comprising:
acquiring a field name of the field from the field; and
storing the field name of the field and the field display identifier into a local information base according to a mapping relationship.

5. The method according to claim 2, wherein decoding the field according to the field display identifier comprises:
acquiring a field value of the field; and
storing the field display identifier and the field value.

6. The method according to claim 2, wherein acquiring the field display identifier comprises acquiring the field display identifier from the field.

7. The method according to claim 6, wherein the field is not a locally recognizable field and the field carries the field display identifier.

8. The method according to claim 2, wherein acquiring the field display identifier comprises:
sending an input prompt to a display device prompting the user to input the field display identifier using a man-machine interface module, wherein the input prompt comprises a field name of the field and a field value of the field; and
receiving the field display identifier input by the user.

9. An encoder, comprising:
an acquiring module, configured to acquire a field and a field display identifier corresponding to the field, wherein the field display identifier comprises a content identifier of the field displayed by an application to a user;
an encoding module, configured to encode the field display identifier acquired by the acquiring module as a part of the field; and
a sending module, configured to send the field with the field display identifier in a file to a decoder, so that when the decoder that decodes the field does not recognize the field, the decoder acquires the field display identifier and decodes the field according to the field display identifier.

10. A decoder, comprising:
a receiving module, configured to receive a file from an encoder, wherein the file comprises a field display identifier corresponding to a field, wherein the field display identifier is encoded as a part of the field;
a determining module, configured to determine whether the field in the file is a locally recognizable field;
an acquiring module, configured to acquire the field display identifier, when the determining module determines that the field is not a locally recognizable field, wherein the field display identifier comprises a content identifier of the field displayed by an application to a user; and
a decoding module, configured to decode the field according to the field display identifier acquired by the acquiring module.

11. The decoder according to claim 10, wherein:
the acquiring module is further configured to acquire a field name of the field from the field; and
the decoder further comprises a storage module, configured to store the field name of the field and the field display identifier obtained by the acquiring module into a local information base according to a mapping relationship.

12. The decoder according to claim 10, wherein the decoding module comprises:
an acquiring unit, configured to acquire a field value of the field; and
a storage unit, configured to store the field display identifier acquired by the acquiring module and the field value acquired by the acquiring unit.

13. The decoder according to claim 10, wherein the field is not a locally recognizable field, the field carries the field display identifier, and the acquiring module is configured to acquire the field display identifier from the field.

14. The decoder according to claim 10, wherein the acquiring module is configured to acquire the field display identifier from the field.

15. The decoder according to claim 10, wherein the acquiring module comprises:
a prompting unit, configured to send an input prompt to a display device prompting the user to input the field display identifier through a man-machine interface module, wherein the input prompt carries a field name of the field and a field value of the field; and
a receiving unit, configured to receive the field display identifier input by the user.

16. A terminal comprising an encoder, the encoder comprising:
an acquiring module, configured to acquire a field and a field display identifier corresponding to the field, wherein the field display identifier comprises a content identifier of the field displayed by an application to a user;
an encoding module, configured to encode the field display identifier as a part of the field acquired by the acquiring module; and
a sending module, configured to send the field with the field display identifier in a file to a decoder, so that when the decoder that decodes the field does not recognize the field, the decoder acquires the field display identifier and decodes the field according to the field display identifier.

17. A terminal comprising a decoder, the decoder comprising:
a receiving module, configured to receive a file from an encoder, wherein the file comprises a field display identifier corresponding to a field, wherein the field display identifier is encoded as a part of the field;
a determining module, configured to determine whether the field in the file is a locally recognizable field;
an acquiring module, configured to acquire the field display identifier, when the determining module determines that the field is not a locally recognizable field, wherein the field display identifier comprises a content identifier of the field displayed by an application to a user; and
a decoding module, configured to decode the field according to the field display identifier acquired by the acquiring module.
